(19) United States
(12) Patent Application Publication
(10) Pub. No.: US 2006/0013971 A1
(43) Pub. Date: Jan. 19, 2006

(54) Porous inkjet recording material

(76) Inventors: Tienteh Chen, San Diego, CA (US); Sandeep Bangaru, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/198,583

(22) Filed: Aug. 4, 2005

Related U.S. Application Data
(63) Continuation-in-part of application No. 10/280,686, filed on Oct. 25, 2002, now Pat. No. 6,905,729.

(51) Int. Cl. B41M 5/40

(52) U.S. Cl. 428/32.34

(57) ABSTRACT

An ink receiving substrate includes a substrate layer and organic modified silica dispensed on at least one surface of the substrate layer, wherein the organic modified silica includes inorganic particulates and substituted or unsubstituted mono amino silane coupling agents.

### RELATED APPLICATIONS

The present application is a continuation-in-part of application entitled, “Active Ligand-Modified Inorganic Porous Coating for Ink-Jet Media” Ser. No. 10/280,686, filed on Oct. 25, 2002, which application is incorporated by reference herein in its entirety.

### BACKGROUND

Inkjet printing has become a popular way of recording images on various media surfaces, particularly paper, for a number of reasons, including, low printer noise, capability of high-speed recording, and multi-color recording. Additionally, these advantages of inkjet printing can be obtained at a relatively low price to consumers. Though there has been great improvement in inkjet printing, improvements are followed by increased demands from consumers for higher speeds, higher resolution, full color image formation, increased stability, etc.

In recent years, as digital cameras and other digital image collecting devices have advanced, image recording technology has attempted to keep pace by improving inkjet image recording on paper sheets and the like. The desired quality level of the inkjet recorded images (“hard copy”) is that of traditional silver halide photography. In other words, consumers would like inkjet recorded images that have the color reproduction, image density, gloss, etc. that is as close to those of silver halide photography as possible.

Ink-jet inks typically comprise an ink vehicle and a colorant, the latter of which may be a dye or a pigment. Dye-based ink-jet inks used in photographic image printing are almost always water-soluble dyes. As a result, such dye-based ink-jet inks are usually not very water fast, i.e. images tend to shift in hue and edge sharpness is reduced upon exposure to humid conditions. In addition, images created from these water-soluble dye-based ink-jet inks tend to fade over time, such as when exposed to ambient light and/or air. Pigment-based inks on the other hand, allow the creation of images that are vastly improved in humid fastness and image fade resistance. Pigment based images, however, are typically inferior to dye-based ink-jet inks with respect to the desirable traits of color saturation, gloss uniformity, and scratch resistance.

For dye based ink, print media surfaces play a key role in the overall image quality, water resistance, and permanence of ink-jet produced printed images. Inkjet recording materials designed for dye based ink can generally be separated into two broad groups: porous media and swellable media.

During printing on a porous media, ink is quickly adsorbed onto the surface which is porous in nature, and if an ionic binding species is present, the colorant can be attracted to the ionic species of opposite charge. This type of media has the advantage of relatively short dry-times, good smearfastness, and often, acceptable water and humidity resistance.

Upon printing on swellable media, ink is absorbed as water contacts and swells a polymer matrix of the coating. The colorant, which is typically a dye, can be immobilized inside the continuous layer of the polymer with significantly limited exposure to the outside environment. Advantages of this approach include much better fade resistance (in both light and dark conditions) than is present with porous media. However, swellable media requires a longer dry time, is not typically as crisp in image quality, and exhibits poor smear fastness.

Though both swellable media and porous media each provide unique advantages in the area of ink-jet printing, popularity of porous media is increasing due to the image crispness and fast dry times. However, the preparation of porous media has unique challenges. Porous media generally includes cationic metal oxide or semimetal oxides such as cationic fumed silica or alumina. However, untreated fumed silica is negatively charged above a pH of 2 and therefore needs to be treated prior to use. However, traditional treatments often create haziness and poor image quality. Some treatments with amino organosilanes provide superior image quality, but exhibit thermal yellowing upon storage at high temperature and high humidity conditions.

### SUMMARY

In one aspect of the present system and method, an ink receiving substrate includes a substrate layer and organic modified silica coated on at least one surface of the substrate layer, wherein the organic modified silica includes inorganic particulates treated with substituted or unsubstituted mono amino silane coupling agents.

In another embodiment, a method for forming an ink receiving substrate includes providing a photobase layer, and coating an organic modified silica layer on at least one surface of the photobase layer, wherein the organic modified silica includes inorganic particulates treated with substituted or unsubstituted mono amino silane coupling agents.

### BRIEF DESCRIPTION OF THE DRAWINGS

The accompanying drawing illustrates various embodiments of the present system and method and is a part of the specification. The illustrated embodiments are merely examples of the present system and method and do not limit the scope thereof.

FIG. 1 is a side cross-sectional view illustrating the layers of a porous inkjet recording substrate, according to one exemplary embodiment.

FIG. 2 is a simple block diagram illustrating a method for forming a porous inkjet recording substrate, according to one exemplary embodiment.

FIG. 3 is a simple block diagram illustrating another method for forming a porous inkjet recording substrate, according to one exemplary embodiment.

FIG. 4 is a simple block diagram illustrating an inkjet material dispensing system, according to one exemplary embodiment.

Throughout the drawings, identical reference numbers designate similar, but not necessarily identical, elements.

### DETAILED DESCRIPTION

Before particular embodiments of the present system and method are disclosed and described, it is to be understood that the present system and method are not limited to the particular process and materials disclosed herein as such may vary to some degree. It is also to be understood that the terminology used herein is used for the purpose of describing particular embodiments only and is not intended to be limiting, as the scope of the present system and method will be defined only by the appended claims and equivalents thereof.

In describing and claiming the present exemplary system and method, the following terminology will be used.

The singular forms “a,” “an,” and “the” include plural referents unless the context clearly dictates otherwise. Thus, for example, reference to “a dye” includes reference to one or more of such materials.

“Media substrate” or “substrate” includes any substrate that can be coated for use in the ink-jet printing arts including, but in no way limited to, resin coated paper (so-called photo base paper), papers, overhead projector plastics, coated papers, fabric, art papers (e.g. water color paper), and the like.

“Porous media” refers to any substantially inorganic particulate-containing coated media having surface voids and/or cavities capable of taking in the ink-jet inks in accordance with embodiments of the present invention. Typically, porous media includes a substrate and a porous ink-receiving layer. As ink is printed on the porous media, the ink can fill the voids and the outermost surface can become dry to the touch in a more expedited manner as compared to traditional or swellable media. Common inorganic particulates that can be present in the coatings include metal oxide or semi-metal oxide particulates, such as silica or alumina. Additionally, in accordance with embodiments of the present invention, the coating can optionally be bound together by a polymeric binder, and can optionally include mordants or ionic binding species that are attractive of classes of predetermined dye species.

“Organosilane reagent” or “reagent” includes compositions that comprise a functional moiety (or portion of the reagent that provides desired modified properties to an inorganic particulate surface), which is covalently attached to a silane coupling group. More specifically, the organosilane reagent of this invention contain monoamino functional group as defined as formula (1) and (2): 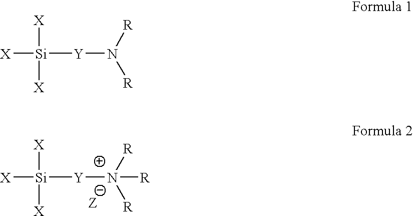
where at least one of X is a halogen, alkoxy, or hydroxyl group configured to attach to the inorganic particulates. Y is a linking group containing from 1 to 20 carbons. Y can be linear or branched hydrocarbons including alkyl, alkylaromatic, substituted aromatic, and can also contain functional groups like ether, urea, urethane, ester, ketone, carbonate, sulfonate, sulfone, and sulfonamide. Y can also be a polyethyleneoxide, a polypropylene oxide, a polyethyleneimine. R can be one of, but is in no way limited to, hydrogen, alkyl (C1 to C20, linear or branched primary, secondary or tertiary), cyclic alkyl, hydroxyalkyl, chloroalkyl, phenyl, substituted phenyl, and the like. Z is counterion and can be a halogen (F, Cl, Br, I), a hydroxyl, a methylsulfate, a tosylate, an acetate, an alkylcarboxylate, or a perchlorate.

Examples of monoamino organosilanes suitable for the present exemplary system and method include, but are in no way limited to those illustrated in Table 1 below:

TABLE 1

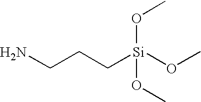

S-1

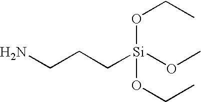

S-2

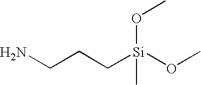

S-3

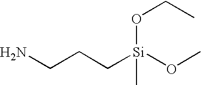

S-4

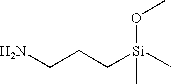

S-5

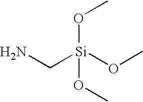

S-6

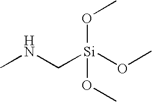

S-7

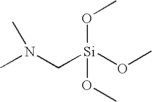

S-8

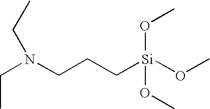

S-9

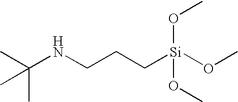

S-10

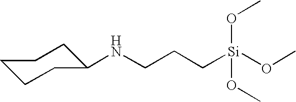

S-11

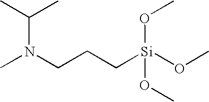

S-12

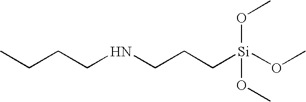

S-13

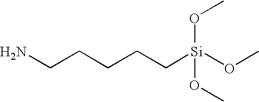

S-14

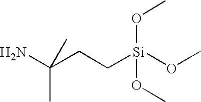

S-15

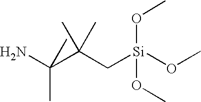

S-16

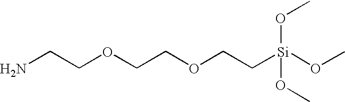

S-17

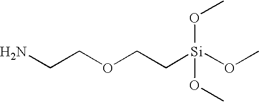

S-18

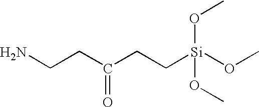

S-19

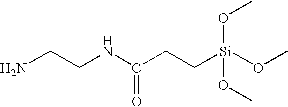

S-20

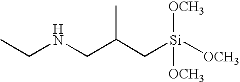

S-21

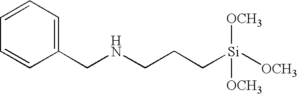

S-22

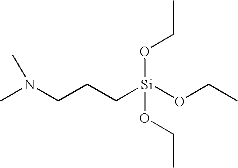

S-23

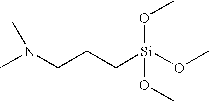

S-24

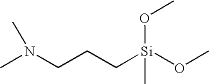

S-25

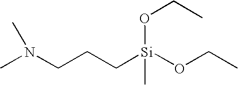

S-26

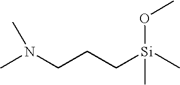

S-27

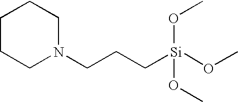

S-28

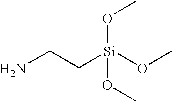

S-29

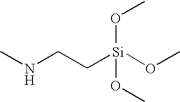

S-30

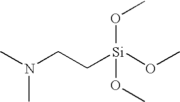

S-31

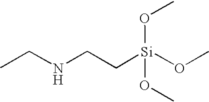

S-32

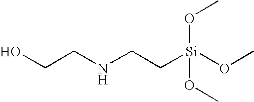

S-33

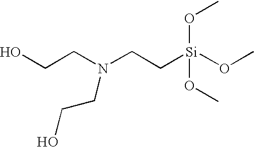

S-34

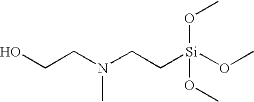

S-35

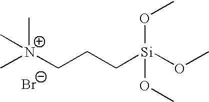

S-36

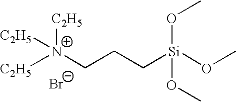

S-37

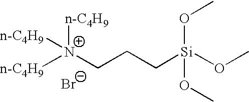

S-38

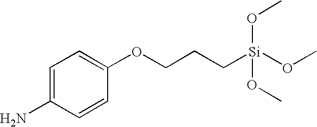

S-39

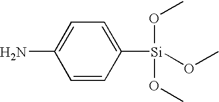

S-40

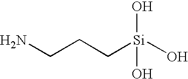

S-41

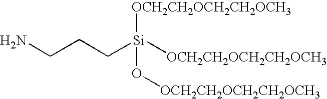

S-42

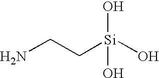

S-43

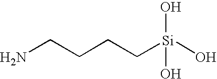

S-44

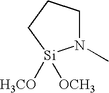

S-45

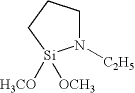

S-46

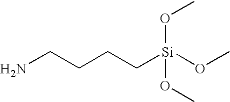

S-47

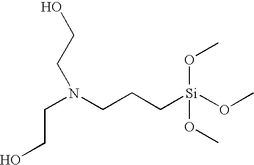

S-48

According to one exemplary embodiment disclosed herein, the porous ink recording material includes organic modified silica prepared by a reaction between a dispersion of fumed silica or alumina and amino silane coupling agents containing substituted and/or unsubstituted mono amino silane coupling agents. The resulting porous ink recording materials exhibited lower tendencies for yellowing over time. Further details of the present ink recording material will be provided below.

The amino organosilanes of the present system and method can be attached to the surface of metal oxides such as silica and alumina via silane coupling reaction. The reaction between the amino organosilanes and metal oxides can be carried out in organic solvents, aqueous solution, or the mixture of organic solvent and water. Water is the most preferred reaction medium. Metal oxides can be dispersed in the presence of amino organosilanes (in-situ method) or the amino organosilanes can be added to the predispersed metal oxides (post-treated method). A high shear device such as rotor/stator, colloid mill, microfluidizer, homogenizer, et al., can be used to facilitate the dispersion of metal oxides in water. For optimum image quality, the particle size of the metal oxides should be less than 0.25 um, according to one exemplary embodiment.

As used in the present specification and in the appended claims, the term “liquid vehicle” is defined to include liquid compositions that can be used to carry colorants, including pigments, to a substrate. Liquid vehicles are well known in the art, and a wide variety of liquid vehicle components may be used in accordance with embodiments of the present exemplary system and method. Such liquid vehicles may include a mixture of a variety of different agents, including without limitation, surfactants, co-solvents, buffers, biocides, viscosity modifiers, sequestering agents, stabilizing agents, and water. Though not liquid per se, the liquid vehicle can also carry other solids, such as polymers, UV curable materials, plasticizers, salts, etc.

“Porous media coating” typically includes inorganic particulates, such as silica particulates, bound together by a polymeric binder. Optionally, mordant and/or other additives can also be present. The composition can be used as a coating for various media substrates, and can be applied by any of a number of methods known in the art. In accordance with the present invention, the inorganic particulates are reagent-modified and surface activated.

“Active ligand” or “active moiety” includes any active portion of an organosilane reagent that provides a function at or near the surface of inorganic particles present in a porous media coating composition that is not inherent to an unmodified inorganic porous particulate. For example, an active ligand can be used to reduce the need for binder in a porous media coating composition, or can be configured to interact with a dye or other ink-jet ink component, thereby improving permanence. For example, an amine can be present on an organosilane reagent to provide a positive charge to attract an anionic dye of an ink-jet ink.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of approximately 1 wt % to about 20 wt % should be interpreted to include not only the explicitly recited concentration limits of 1 wt % to about 20 wt %, but also to include individual concentrations such as 2 wt %, 3 wt %, 4 wt %, and sub-ranges such as 5 wt % to 15 wt %, 10 wt % to 20 wt %, etc.

In the following description, for purposes of explanation, numerous specific details are set forth in order to provide a thorough understanding of the present system and method for producing an exemplary porous ink recording material having improved yellowing qualities. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

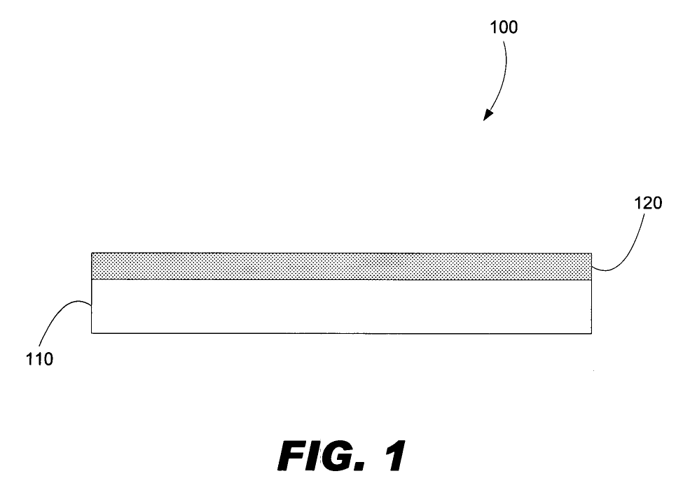

FIG. 1 illustrates an exemplary porous ink receiving substrate (100) configured to receive an inkjet ink to according to one exemplary embodiment. As shown in FIG. 1, the present exemplary ink receiving substrate (100) includes a photobase layer (110) and a porous media coating (120). While the exemplary ink receiving substrate (100) illustrated in FIG. 1 is shown having the porous media coating (120) formed on a single side of the photobase layer (110), any number of exposed surfaces of the photobase layer may be coated by the porous media coating. According to one exemplary embodiment, the ink receiving substrate (100) includes a single photobase layer (110) sandwiched between a plurality of porous media coatings (120), as described herein.

As mentioned with reference to FIG. 1, the present exemplary ink receiving substrate (100) includes a photobase layer (110) and at least one porous media coating (120). As a result of the present formulation, the disclosed ink receiving substrate (100) exhibits lower yellowing than silica modified with amino silanes containing more than one amino functional groups. The individual components of the present ink receiving substrate (100) will be described in further detail below.

Photobase Paper

As mentioned previously, the present exemplary ink receiving substrate (100) is formed on a photobase layer (110) or support. According to one exemplary embodiment, any number of traditional photobase supports used in the manufacture of transparent or opaque photographic material may also be employed in the practice of the present system and method. Examples include, but are not limited to, clear films, such a cellulose esters, including cellulose triacetate, cellulose acetate, cellulose propionate, or cellulose acetate butyrate, polyesters, including poly(ethylene terephthalate), polyimides, polycarbonates, polyamides, polyolefins, poly(vinyl acetals), polyethers, polyvinyl chloride, and polysulfonamides. Polyester film supports, and especially poly(ethylene terephthalate), such as manufactured by du Pont de Nemours under the trade designation of MELINEX, may be selected because of their excellent dimensional stability characteristics. Further, opaque photographic materials may be used as the photobase layer (110) including, but in no way limited to, baryta paper, polyethylene-coated papers, and voided polyester.

Non-photographic materials, such as transparent films for overhead projectors, may also be used for the support material or the photobase layer (110). Examples of such transparent films include, but are not limited to, polyesters, diacetates, triacetates, polystyrenes, polyethylenes, polycarbonates, polymethacrylates, cellophane, celluloid, polyvinyl chlorides, polyvinylidene chlorides, polysulfones, and polyimides.

Additional support materials that may be incorporated by the present system and method to serve as the photobase layer (110) include plain paper of various different types, including, but in no way limited to, pigmented papers and cast-coated papers, as well as metal foils, such as foils made from alumina.

Porous Media Coating

Continuing with FIG. 1, the present exemplary ink receiving substrate (100) includes at least one porous media coating (110). According to the present exemplary embodiment, the at least one porous media coating (110) includes at least one layer of inorganic particles such as fumed silica or alumina treated with silane coupling agents containing substituted and/or unsubstituted mono amino silane coupling agents.

As mentioned above, the porous media coating (110) includes a number of inorganic particles. According to this exemplary embodiment, the inorganic particles comprise a fumed silica or alumina. According to this exemplary embodiment, the fumed silica may be any silica in colloidal form. Specifically, according to one exemplary embodiment, the aggregate size of the fumed silica is between approximately 50 to 300 nm in size. More specifically, the fumed silica is preferred between approximately 100 to 250 nm in size. The Brunauer-Emmett-Teller (BET) surface area of the fumed silica is between approximately 100 to 350 square meters per gram. More specifically, the fumed silica is preferred to have a BET surface area of 150 to 250 square meters per gram. Accordingly, the zeta potential, or the electrokinetic measurement used to control the stability of a colloid, of the organic treated silica at a pH of 3.5 is at least 20 mV.

Alternatively, the inorganic particles may include alumina particles. According to one exemplary embodiment, the alumina coating comprises pseudo-boehmite, which is aluminum oxide/hydroxide (Al₂O₃.n H₂O where n is from 1 to 1.5). More preferably, the photobase layer (172) is coated with an alumina that comprises rare earth-modified boehmite, containing from about 0.04 to 4.2 mole percent of at least one rare earth metal having an atomic number from 57 to 71 of the Periodic Table of Elements. According to this exemplary embodiment, the rare earth elements are selected from the group consisting of lanthanum, ytterbium, cerium, neodymium, praseodymium, and mixtures thereof. The presence of the rare earth changes the pseudo-boehmite structure to the boehmite structure. The presence of the rare earth element provides superior lightfastness, compared with an alumina basecoat not including the rare earth element. The preparation of the pseudo-boehmite layer modified with rare earths is more fully described in U.S. Pat. No. 6,156,419, the contents of which are incorporated herein by reference.

In addition to the above-mentioned inorganic particulates, the at least one porous media coating (110) includes an amino silane coupling agent containing substituted or unsubstituted mono amino silane coupling agents. A general formula of the present amino silane coupling agent containing substituted or unsubstituted mono amino silane coupling agents is illustrated below with reference to Formula 3 below:
X₃Si—Y—N(R)₂ Formula 3
where at least one of X is a halogen, alkoxy, or hydroxyl group configured to attach to the inorganic particulates. Y is a linking group containing from 1 to 20 carbons. Y can be a linear or branched hydrocarbon including alkyl, alkylaromatic, substituted aromatic, and can also contain functional groups like ether, urea, urethane, ester, ketone, carbonate, sulfonate, sulfone, and sulfonamide. Y can also be a polyethyleneoxide, a polypropylene oxide, a polyethyleneimine. R can be one of, but is in no way limited to, hydrogen, alkyl (C1 to C20, linear or branched primary, secondary or tertiary), cyclic alkyl, hydroxyalkyl, chloroalkyl, phenyl, substituted phenyl, and alkylaromatic, and the like.

According to one exemplary embodiment, the above-mentioned amino silane coupling agent includes compositions that comprise an active ligand grouping (or portion of the reagent that provides desired modified properties to an inorganic particulate surface of the porous media coating) covalently attached to a silane grouping. Examples of active ligand groupings can include ultraviolet absorbers, metal chelators, hindered amine light stabilizers, reducing agents, hydrophobic groups, ionic groups, buffering groups, or functionalities for subsequent reactions. The active ligand group can be attached directly to the silane grouping, or can be appropriately spaced from the silane grouping, such as by from 1 to 10 carbon atoms or other known spacer groupings. The silane grouping of the organosilane reagent can be attached to inorganic particulates of the porous media coating composition through hydroxyl groups, halo groups, or alkoxy groups present on the reagent.

In addition to the inorganic particulates and the amino silane coupling agent containing substituted or unsubstituted mono amino silane coupling agents mentioned above, the present porous media coating may also include a number of additives such as polyvalent salt of metal of Group II and Group III of the periodic Table. For example, salt of a metal selected from the group comprising trivalent aluminum, chromium, gallium, indium, thallium, tetravalent titanium, germanium, zirconium, tin, cerium, hafnium, and thorium. Preferred metals include aluminum, zirconium, and thorium. Especially preferred metal salts include Aluminum chloride hydrate (ACH) or polyaluminum chloride (PAC).

“Aluminum chloride hydrate,” “ACH,” “polyaluminum chloride,” “PAC,” “polyaluminum hydroxychloride,” or the like, refers to a class of soluble aluminum products in which aluminum chloride has been partly reacted with base. The relative amount of OH—, compared to the amount of Al, can determine the basicity of a particular product. The chemistry of ACH is often expressed in the form Alₙ(OH)ₘCl(₃ₙ₋ₘ), wherein n can be from 1 to 50, and m can be from 1 to 150. Basicity can be defined by the term m/(3n) in that equation. ACH (or PAC) can be prepared by reacting hydrated alumina Al(OH)₃ with hydrochloric acid (HCl). The exact composition depends upon the amount of hydrochloric acid used and the reaction conditions. Typically the reaction will be done to give a product with a basicity of 40% to 60%, which can be defined as (%) =n/6×100. ACH can be supplied as a solution, but can also be supplied as a solid.

There are other ways of referring to ACH, which are known in the art. Typically, ACH comprises many different molecular sizes and configurations in a single mixture. An exemplary stable ionic species in ACH can have the formula [Al₁₂(OH)₂₄AlO₄(H₂O)₁₂]⁷⁺. Other examples include [Al₆(OH)₁₅]³⁺, [Al₈(OH)₂₀]⁴⁺, [Al₁₃(OH)₃₄]⁵⁺, [Al₂₁(OH)₆₀]³⁺, etc. Other common names used to describe components that can be present in an ACH composition include Aluminum chloride hydroxide (8Cl); A 296; ACH 325; ACH 331; ACH 7-321; Aloxicoll; Aloxicoll LR; Aluminium hydroxychloride; Aluminol ACH; Aluminum chlorhydrate; Aluminum chlorhydroxide; Aluminum chloride hydroxide oxide, basic; Aluminum chloride oxide; Aluminum chlorohydrate; Aluminum chlorohydrol; Aluminum chlorohydroxide; Aluminum hydroxide chloride; Aluminum hydroxychloride; Aluminum oxychloride; Aquarhone; Aquarhone 18; Astringen; Astringen 10; Banoltan White; Basic aluminum chloride; Basic aluminum chloride, hydrate; Berukotan AC-P; Cartafix LA; Cawood 5025; Chlorhydrol; Chlorhydrol Micro-Dry; Chlorhydrol Micro-Dry SUF; E 200; E 200 (coagulant); Ekoflock 90; Ekoflock 91; GenPac 4370; Gilufloc 83; Hessidrex WT; HPB 5025; Hydral; Hydrofugal; Hyper Ion 1026; Hyperdrol; Kempac 10; Kempac 20; Kemwater PAX 14; Locron; Locron P; Locron S; Nalco 8676; OCAL; Oulupac 180; PAC; PAC (salt); PAC 100W; PAC 250A; PAC 250AD; PAC 300M; PAC 70; Paho 2S; PALC; PAX; PAX 11S; PAX 16; PAX 18; PAX 19; PAX 60p; PAX-XL 1; PAX-XL 19; PAX-XL 60S; PAX-XL 61S; PAX-XL 69; PAX-XL 9; Phacsize; Phosphonorm; (14) Poly(aluminum hydroxy) chloride; Polyaluminum chloride; Prodefloc AC 190; Prodefloc AL; Prodefloc SAB 18; Prodefloc SAB 18/5; Prodefloc SAB 19; Purachem WT; Reach 101; Reach 301; Reach 501; Sulzfloc JG; Sulzfloc JG 15; Sulzfloc JG 19; Sulzfloc JG 30; TAI-PAC; Taipac; Takibine; Takibine 3000; Tanwhite; TR 50; TR 50 (inorganic compound); UPAX 20; Vikram PAC-AC 100S; WAC; WAC 2; Westchlor 200; Wickenol 303; Wickenol CPS 325 Aluminum chlorohydrate Al₂ClH₅O₅ or Al₂(OH)₅Cl.2H₂O or [Al(OH)₂Cl]ₓ or Al₆(OH)₁₅Cl₃; Al₂(OH)₅O₅ or chlorohydroxide; Aluminum hydroxychloride; Aluminum chloride, basic; Aluminum chloride hydroxide; [Al₂(OH)ₙCl₆₋ₙ]ₘ; [Al(OH)₃]ₙAlCl₃; or Alₙ(OH)ₘCl₍₃ₙ₋ₘ₎ 0<m<3n; for example. Highly preferred are aluminum chlorides and aluminum nitrates of the formula Al(OH)₂X to Al₃(OH)₈X, where X is Cl or NO₃, and most preferably, the silica particles are contacted with an aluminum chlorohydrate Al₂(OH)₅Cl, more specifically Al₂(OH)Cl₅.nH₂O. It is believed that contacting a silica particle with aluminum compounds as described above causes suitable aluminum compounds to become associated with or bind to the surface of the silica particles, possibly covalently or through an electrostatic interaction, to form a cationic charged silica, which can be measured by a Zeta potential instrument.

In addition to the above-mentioned components, the porous media coating (110) may also contain any number of mordants, surfactants, buffers, plasticizers, and/or other additives that are well known in the art. The mordant may be a cationic polymer, such as a polymer having a primary amino group, a secondary amino group, a tertiary amino group, a quaternary ammonium salt group, or a quaternary phosphonium salt group. The mordant may be in a water-soluble form or in a water-dispersible form, such as in latex. The water-soluble cationic polymer may include, but is in no way limited to, a polyethyleneimine, a polyallylamine, a polyvinylamine, a dicyandiamide-polyalkylenepolyamine condensate, a polyalkylenepolyamine-dicyandiamideammonium condensate, a dicyandiamide-formalin condensate, an addition polymer of epichlorohydrin-dialkylamine, a polymer of diallyldimethylammoniumchloride (“DADMAC”), a copolymer of diallyldimethylammoniumchloride-SO₂, polyvinylimidazole, polyvinypyrrolidone, a copolymer of vinylimidazole, polyamidine, chitosan, cationized starch, polymers of vinylbenzyltrimethylqammoniumchloride, (2-methacryloyloxyethyl)trimethyl-ammoniumchloride, and polymers of dimethylaminoethylmethacrylate. Examples of the water-soluble cationic polymers that are commercially available in latex form and are suitable as mordants are TruDot P-2604, P-2606, P-2608, P-2610, P-2630, and P-2850 (available from MeadWestvaco Corp. (Stamford, Conn.)) and Rhoplex® Primal-26 (available from Rohm and Haas Co. (Philadelphia, Pa.)). It is also contemplated that cationic polymers having a lesser degree of water-solubility may be used in the ink-receiving layer 4 by dissolving them in a water-miscible organic solvent.

A metal salt, such as a salt of an organic or inorganic acid, an organic metal compound, or a metal complex, may also be used as the mordant. For instance, since aluminum salts are inexpensive and provide the desired properties in the ink-receiving layer 4, an aluminum salt may be used. The aluminum salt may include, but is not limited to, aluminum fluoride, hexafluoroaluminate (for example, potassium salts), aluminum chloride, basic aluminum chloride (polyaluminum chloride), tetrachloroaluminate (for example, sodium salts), aluminum bromide, tetrabromoaluminate (for example, potassium salts), aluminum iodide, aluminate (for example, sodium salts, potassium salts, and calcium salts), aluminum chlorate, aluminum perchlorate, aluminum thiocyanate, aluminum sulfate, basic aluminum sulfate, aluminum sulfate potassium (alum), ammonium aluminum sulfate (ammonium alum), sodium sulfate aluminum, aluminum phosphate, aluminum nitrate, aluminum hydrogenphosphate, aluminum carbonate, polyaluminum sulfate silicate, aluminum formate, aluminum diformate, aluminum triformate, aluminum acetate, aluminum lactate, aluminum oxalate, aluminum isopropionate, aluminum butyrate, ethyl acetate aluminum diisopropionate, aluminum tris(acrylacetonate), aluminum tris(ethylacetoacetate), and aluminum monoacetylacetonate-bis(ethylaceto-acetate). Preferably, the mordant is a quaternary ammonium salt, such as a DADMAC derivative; an aluminum salt, such as aluminum triformate or aluminum chloride hydrate; or a cationic latex that includes quaternary ammonium functional groups, like TruDot P-2608. These are commercially available from numerous sources, such as BASF Corp. (Mount Olive, N.J.), Ciba Specialty Chemicals (Basel, Switzerland), and MeadWestvaco Corp. (Stamford, Conn.).

Exemplary Formation Methods

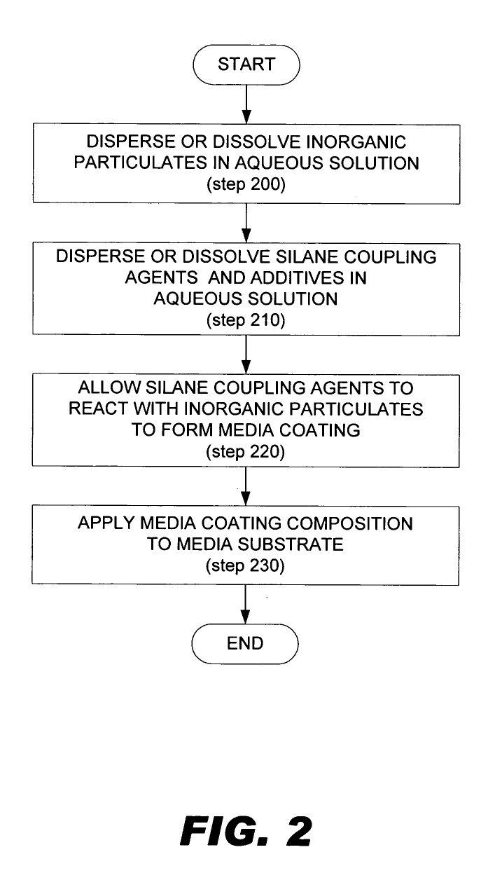

FIG. 2 illustrates an exemplary method for forming the present porous inkjet material substrate. While the method presented and described with respect to FIG. 2 is discussed in a particular order, it will be appreciated by one of ordinary skill in the art that a number of the various steps described may be performed simultaneously or in alternate sequences. As illustrated in FIG. 2, the exemplary method for forming the present inkjet material substrate begins by first dispersing or dissolving the inorganic porous particulates in an aqueous solution (step 200). As mentioned previously, the inorganic porous particulates may include, but are in no way limited to fumed silica and/or alumina.

Once the inorganic porous particulates are dispersed in the aqueous solution (step 200), the silane coupling agents containing substituted and/or unsubstituted mono aminosilane coupling agents, as well as any desired additives are dispersed in the aqueous solution (step 210). According to one exemplary embodiment of the present system and method, the amount of silane coupling agent used may vary from approximately 0.1 to 30% based on the weight of the silica or alumina. A more preferred range of the silane coupling agent used may vary from approximately 1 to 10% by weight based on the weight of fumed silica or alumina. According to one exemplary embodiment, the silane coupling agents may be added to the aqueous solution in excess, followed by a further step of decanting the excess active ligand-containing reagent prior to the coating step.

Once the inorganic porous particulates and the silane coupling agents are combined in the aqueous solution, they will react to form organic modified silica (step 220). According to one exemplary embodiment, the silane coupling agents are covalently bonded to the inorganic porous particulates when combined in the aqueous solution. According to one exemplary embodiment, the reaction between the silane coupling agents, the inorganic porous particulates, and any other additives such as ACH may be accelerated by heating the resulting mixture to between approximately 50 to 80° C and maintaining the solution at a pH of between approximately 3 and 7.

While the above-mentioned exemplary embodiment is described as selectively combining the inorganic porous particulates and the silane coupling agents in a single aqueous solution to facilitate the reaction, a number of modifications may be made to the described method to produce the present results. According to one alternative exemplary embodiment, the inorganic porous particulates can be dispersed or dissolved separately in water, and then the aqueous organosilane reagent can be mixed together for the reacting step.

Once the silane coupling agents have reacted with the inorganic porous particulates (step 220), the resulting media coating composition may then be applied to a media substrate (step 230). According to one exemplary embodiment, the resulting media coating composition can be applied to the media substrate to form the ink-receiving layer (step 230) by any means known to one skilled in the art including, but in no way limited to, blade coating, air knife coating, rod coating, wire rod coating, roll coating, slot coating, slide hopper coating, gravure, curtain, or cascade coating. The ink-receiving layer can be printed on one or both sides of the media substrate. In one embodiment of the present exemplary method, the thickness of the ink-receiving layer formed by the coating composition can be from about 20 μm to about 60 μm. If applied as a second media topcoat, the thickness can range from 0.1 μm to 10 μm, and in a more specific embodiment, from 1 μm to 5 μm. According to one exemplary embodiment, the coating composition is formed such that the fumed silica is distributed at between approximately 0.01 to 0.03 grams per square meter.

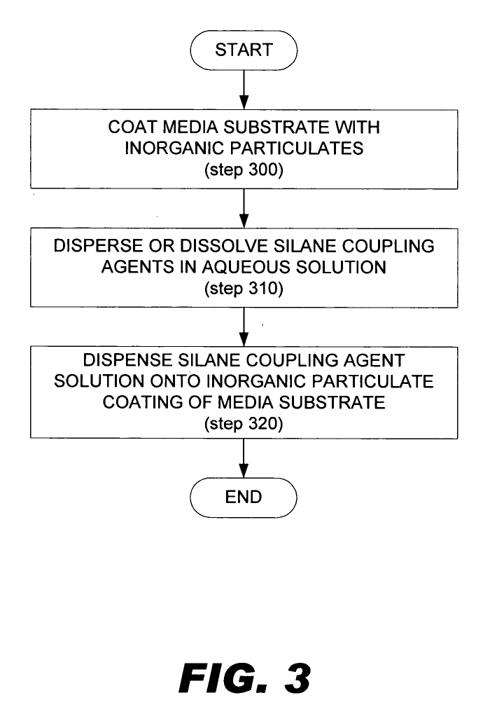

FIG. 3 illustrates an alternative exemplary method for forming the present exemplary porous inkjet material substrate. As illustrated in FIG. 3, the present exemplary porous inkjet material substrate may be formed by first coating a media substrate with inorganic porous particulates (step 300), according to known methods. Additionally, as shown in FIG. 3, the silane coupling agents containing substituted and/or unsubstituted mono aminosilane coupling agents are dispersed or dissolved in an aqueous solution (step 310) to form a liquid coating composition. The liquid coating composition containing the silane coupling agents may then be dispensed onto the substrate having the inorganic porous particulates formed thereon (step 320) to form the desired media coating composition. According to one exemplary embodiment, additives such as surfactants can be incorporated into the liquid coating composition to enhance uniform wetting/coating of the substrate.

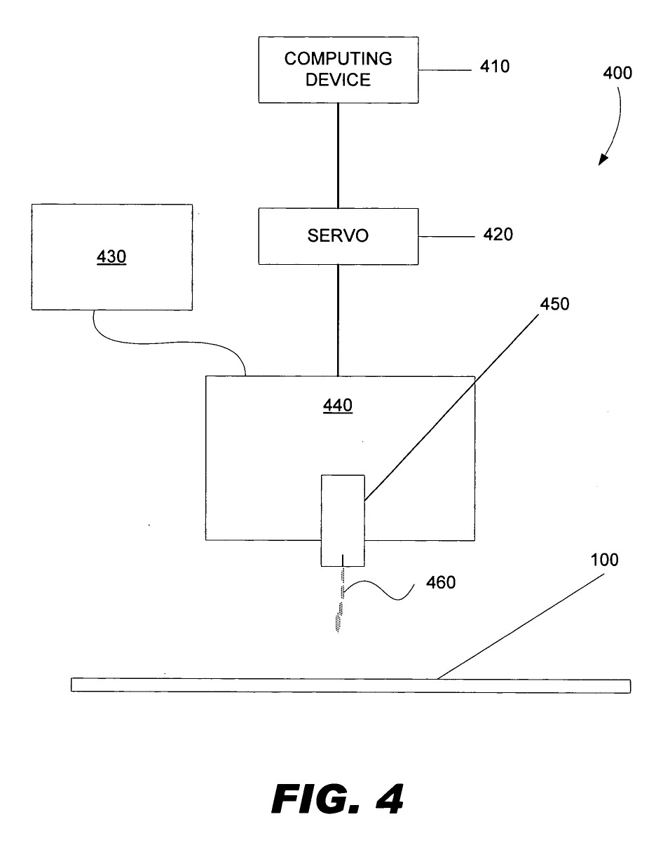

Once the desired media coating composition is formed on the desired substrate, a desired object may be printed thereon, as will be described in detail below with reference to FIG. 4.

Exemplary System

FIG. 4 illustrates an exemplary inkjet printing system (400) configured to form a desired object on the above-mentioned exemplary porous inkjet material substrate. As shown in FIG. 4, the present exemplary inkjet printing system (400) includes a computing device (410) controllably coupled through a servo mechanism (420) to a moveable carriage (140) having an inkjet dispenser (450) disposed thereon. A material reservoir (430) is coupled to the moveable carriage (440), and consequently, to the inkjet print head (450). A number of rollers (480) or other transport medium may be located adjacent to the inkjet dispenser (450) configured to selectively position the ink receiving substrate (100). The above-mentioned components of the present exemplary system (400) will now be described in further detail below.

The computing device (410) that is controllably coupled to the servo mechanism (420), as shown in FIG. 4, controls the selective deposition of an inkjet ink (460) on an ink receiving substrate (470). A representation of a desired image or text may be formed using a program hosted by the computing device (410). That representation may then be converted into servo instructions that are then housed in a processor readable medium (not shown). When accessed by the computing device (410), the instructions housed in the processor readable medium may be used to control the servo mechanisms (420) as well as the movable carriage (440) and inkjet dispenser (450). The illustrated computing device (410) may be, but is in no way limited to, a workstation, a personal computer, a laptop, a digital camera, a personal digital assistant (PDA), or any other processor containing device.

The moveable carriage (440) of the present exemplary inkjet printing system (400) is a moveable material dispenser that may include any number of inkjet material dispensers (450) configured to dispense the inkjet ink (460). The moveable carriage (440) may be controlled by a computing device (410) and may be controllably moved by, for example, a shaft system, a belt system, a chain system, etc. making up the servo mechanism (420). As the moveable carriage (440) operates, the computing device (410) may inform a user of operating conditions as well as provide the user with a user interface.

As a desired image or text is printed on the ink receiving substrate (100), the computing device (410) may controllably position the moveable carriage (440) and direct one or more of the inkjet dispensers (450) to selectively dispense an inkjet ink at predetermined locations on the ink receiving substrate (470) as digitally addressed drops, thereby forming the desired image or text. The inkjet material dispensers (450) used by the present exemplary inkjet printing system (400) may be any type of inkjet dispenser configured to perform the present method including, but in no way limited to, thermally actuated inkjet dispensers, mechanically actuated inkjet dispensers, electrostatically actuated inkjet dispensers, magnetically actuated dispensers, piezoelectrically actuated dispensers, continuous inkjet dispensers, etc. Additionally, the present ink receiving substrate (470) may receive inks from non-inkjet sources such as, but in no way limited to, screen printing, stamping, pressing, gravure printing, and the like.

The material reservoir (430) that is fluidly coupled to the inkjet material dispenser (450) houses and supplies an inkjet ink (460) to the inkjet material dispenser. The material reservoir may be any container configured to hermetically seal the inkjet ink (460) prior to printing.

According to the present exemplary embodiment, the inkjet ink (460) contained by the reservoir (430) may include, but is in no way limited to, pigment-based and dye-based inkjet inks. Appropriate dye-based inks include, but are in no way limited to anionic dye-based inks having water-soluble acid and direct dyes. Similarly, appropriate pigment-based inks include both black and colored pigments. Moreover, the inkjet ink compositions of the present exemplary systems and methods are typically prepared in an aqueous formulation or liquid vehicle that can include, but is in no way limited to, water, cosolvents, surfactants, buffering agents, biocides, sequestering agents, viscosity modifiers, humectants, binders, and/or other known additives.

FIG. 4 also illustrates the components of the present system that facilitate reception of the inkjet ink (460) onto the ink receiving substrate (100). As shown in FIG. 4, a number of positioning rollers (480) may transport and/or positionally secure an ink receiving substrate (100) during a printing operation. Alternatively, any number of belts, rollers, substrates, or other transport devices may be used to transport and/or positionally secure the ink receiving substrate (100) during a printing operation, as is well known in the art.

### EXAMPLES

The following examples illustrate a number of embodiments of the present systems and methods that are presently known. However, it is to be understood that the following are only exemplary or illustrative of the application of the principles of the present systems and methods. Numerous modifications and alternative compositions, methods, and systems may be devised by those skilled in the art without departing from the spirit and scope of the present systems and methods. The appended claims are intended to cover such modifications and arrangements. Thus, while the present systems and methods have been described above with particularity, the following examples provide further detail in connection with what are presently deemed to be the acceptable embodiments.

### Example 1

### Treatment of Cab-O—Sil M-5 with 3-Aminopropyl trimethoxysilane (Silquest A-1110)

Fumed silica Cab-O—Sil M-5 (from Cabot Chemical Corp.) was dispersed in water with an Ross Mixer Model L-1000 lab rotor/stator. The % solid was about 20.94% and pH was about 2.0. 200g of pre-dispersed M-5 was stirred with a mechanical stirrer and the solution was placed in a sonication bath. 9.32 g 20% methanol solution of 3-Aminopropyltrimethoxysilane (Silquest A-1110) was added drop-wisely to the M-5 dispersion with sonication at room temperature. Final pH was adjusted to between 4.5 and 5.0 with 1 M HCl. Sonication was continued for 15 minutes after the addition of A-1110 to remove gel particles. The mixture was heated in a water bath at 80° C. for one hour with stirring. The mixture was cooled to room temperature and filtered through a 500 mesh sieve. The isoelectric point (IEP) of the organic modified silica measured by Malvern Nanosizer was about 7.92.

### Examples 2 through 12

Cab-O—Sil M-5 treated with other mono, di, tri, and quarternary amino silane coupling agents was performed using a method similar to that illustrated in Example 1. The % treatment and the isoelectric point M-5 treated with exemplary mono, di, tri, and quaternary amino silanes are shown below in Table 2.

TABLE 2

| Organic | | | | | Class of |
|---|---|---|---|---|---|
| Modified | | | % | Isoelectric | Amino |
| Silica ID | Amino Silane | Tradename | Treatment | Point | Silanes |
| OS-1 | 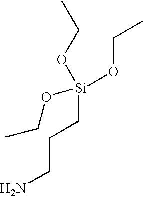 | Silquest A-1110 | 4.45 | 7.92 | Monoamine (Invention) |
| OS-2 | 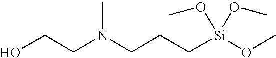 | Gelest SIH6172.0 | 4.75 | 7.41 | Monoamine (Invention) |
| OS-3 | 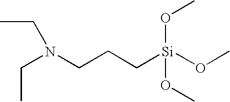 | Gelest SID 3396.0 | 4.71 | 7.97 | Monoamine (Invention) |
| OS-4 | 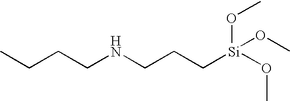 | Gelest SIB1932.2 | 4.71 | 8.08 | Monoamine (Invention) |
| OS-5 | 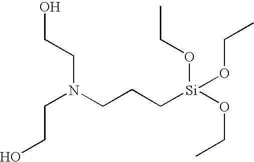 | Gelest SIT 1140.0 | 12.3 | 7.22 | Monoamine (Invention) |
| OS-6 | 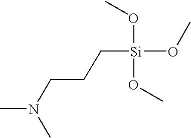 | Gelest SID 3547.0 | 4.15 | 7.72 | Monoamine (Invention) |
| OS-7 | 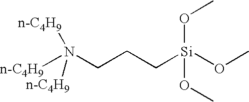 | Gelest SIT 8414 | 7.69 | 8.39 | Monoamine (Invention) |
| OS-8 | 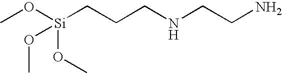 | Silquest A-1120 | 4.45 | 7.92 | Diamine (Control) |
| OS-9 | 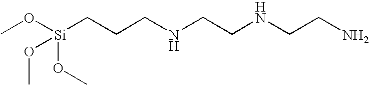 | Silquest A-1130 | 4.45 | 8.33 | Triamine (Control) |
| OS-10 | 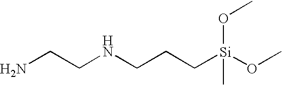 | Silquest A-2120 | 4.45 | 8.11 | Diamine (Control) |
| OS-11 | Prehydrolyzed Oligomer based | Gelest | 4.45 | 8.3 | Diamine |
| | on Silquest A-1120 | WSA-7021 | | | (Control) |
| OS-12 | Prehydrolyzed Oligomer based | Degussa | 5.93 | 8.19 | Diamine |
| | on Silquest A-1120 | Dynasylan-1161 | | | (Control) |

### Example 13

### Combination Treatment of Fumed Silica with Aluminumchlorohydrate (ACH) and 3-Aminopropyltrimethoxysilane

480 g of deionized water was charged to a 1 liter beaker and the solution was stirred with a Ross Mixer Model L-1000. 4.8 g of 50% aluminumchlorohydrate was added and stirred for 10 minutes. 7.2 g of 3-aminopropyltrimethoxysilane (Silquest A-1110) was added and stirred 10 more minutes. pH was adjusted to 9.3 with 1M HCl. 120 g of Cab-O—Sil fumed silica MS-75D was added over 15 minutes. RPM of the Ross Mixer increased from 5000 to 7000. Final pH of the dispersion was 5.5. Dispersion was continued for 10 minutes at 7000 RPM and sonicated 10 more minutes. The Z-ave particle size was 114 nm measured by Malvern Nanosizer. The dispersion was heated in a 80° C. water bath for two hours to complete the treatment. Final pH was 4.38. The isoelectric point was 8.28.

### Example 14

### Preparation of Coating Formulation for Inkjet Recording Materials

Cationic silica dispersion prepared in examples 1 to 13 were used for porous inkjet recording materials. The typical coating formulation of inkjet recording materials comprising organic modified silica is shown in Table 3 below in which Poval 235 is polyvinyl alcohol manufactured by Kuraray Chemical.

TABLE 3

| Ingredients | Part |
|---|---|
| Organic Modified Silica | 100 |
| Thiodiethanol | 2 |
| Glycerol | 1 |
| Boric Acid | 3.5 |
| Poval 235 | 18 |
| Olin 10G | 0.25 |

In one example the ingredients listed in Table 3 were mixed at 40° C. with a mechanical stirrer. The solution was then sonicated for 5 minutes to remove air bubbles. After mixture and sonication, the total percentage of solids in the coating fluids was about 16.5%. The coating fluids were then dispensed on a gel subbed photobase paper with a Mylar rod. The final dry coatweights were approximately 35 um.

Once formed, the inkjet recording materials containing the present organic modified silica were placed in a 60° C./80% humidity chamber to test their resistance to yellowing. The increases of yellow optical density were measured with a Macbeth Densitometer. Table 4 below illustrates the amino silanes used from Table 1, their structures, and the yellowing induced by temperature and humidity.

TABLE 4

| Inkjet | Organic | | | |
|---|---|---|---|---|
| Coating | Modified | | Yellow | |
| ID | Silica | Amine | ΔDmin * | Remark |
| 1 | OS-5 | SIB 1140 - mono-Amine | 0.0333 | |
| 2 | OS-2 | SIH 6172 - mono-Amine | 0.033 | |
| 3 | OS-4 | SIB 1932.2 - mono- | 0.0357 | |
| | | Amine | | |
| 4 | OS-6 | SID 3547 - mono-Amine | 0.0343 | |
| 5 | OS-7 | SIT 8414 - mono-Amine | 0.0497 | |
| 6 | OS-3 | SID 3396 - mono-Amine | 0.0337 | |
| 7 | OS-1 | A1110- mono-Amine | 0.0507 | |
| 8 | OS-12 | DS-1161-diamine | 0.0923 | Control |
| 9 | OS-9 | SIT 8398 - triple | 0.1183 | Control |
| | | Amine | | |
| 10 | OS-10 | A2120 - double Amine | 0.1357 | Control |
| 11 | OS-8 | A1120 - double Amine | 0.1387 | Control |
| 12 | OS-9 | A1130 - triple Amine | 0.198 | Control |

* 9 weeks at 60° C./80% humidity chamber

As illustrated in Table 4 above, the silane coupling agents containing mono amine or derivatives of mono amines have much improved resistance to yellowing when compared to similar di- and tri-amino silane coupling agents.

In conclusion, the porous ink recording material formed by the above-mentioned systems and methods includes organic modified silica prepared by a reaction between a dispersion of inorganic particulates and amino silane coupling agents containing substituted and/or unsubstituted mono amino silane coupling agents. The resulting porous ink recording materials exhibited lower tendencies for yellowing over time when compared to silica modified with multiple amino silanes.

The preceding description has been presented only to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

What is claimed is:

1. An ink receiving substrate comprising:
a photobase layer; and
an inorganic oxide dispensed on at least one surface of said photobase layer;
wherein said inorganic oxides includes inorganic oxide particulates and substituted or unsubstituted mono amino silane coupling agents.

2. The ink receiving substrate of claim 1, wherein said inorganic oxide particulates comprise one of a fumed silica, a colloidal silica, a boehmite, a pseudo-boehmite, a colloidal aluminum oxide, a precipitated calcium carbonate, or a grounded calcium carbonate.

3. The ink receiving substrate of claim 1, wherein said silane coupling agents have the general structure of: 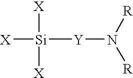
wherein:
at least one of X comprises a halogen, an alkoxy, or a hydroxyl group configured to attach to said inorganic particulates;
Y comprises a linking group containing from 1 to 20 carbons; and
R comprises one of a hydrogen, an alkyl (C1 to C20, linear or branched primary, secondary or tertiary), a cyclic alkyl, a hydroxyalkyl, a chloroalkyl, a phenyl, or a substituted phenyl.

4. The ink receiving substrate of claim 3, wherein Y comprises one of a linear or a branched hydrocarbon, a polyethyleneoxide, a polypropylene oxide, or a polyethyleneimine.

5. The ink receiving substrate of claim 4, wherein Y further comprises one of an alkyl, an alkylaromatic, a substituted aromatic, an ether, a urea, a urethane, an ester, a ketone, a carbonate, a sulfonate, a sulfone, or a sulfonamide.

6. The ink receiving substrate of claim 3, wherein said silane coupling agent comprises one of 3-aminopropyltrimethoxysilane, 3-aminopropyltriethoxysilane, 3-aminopropylmethyldimethoxysilane, N-methylaminopropyltrimethoxysilane, N-ethylaminopropyltrimethoxysilane, N-butylaminopropyltrimethoxysilane, tert-butlyaminopropyltrimethoxysilane, N,N-dimethylaminopropyltrimethoxysilane, N-ethylaminoisobutylmethyltrimethoxysilane, bis(2-hydroxyethyl)-3-aminopropyltrimethoxysilane, N-hydroxethyl-3-aminopropyltrimethoxysilane, aminopropylsilanetriol, aminoethytrimethoxysilane, or aminobutyltrimethoxysilane.

7. The ink receiving substrate of claim 1, wherein said silane coupling agents have the general structure of: 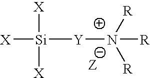
wherein:
at least one of X comprises a halogen, an alkoxy, or a hydroxyl group configured to attach to said inorganic particulates;
Y comprises a linking group containing from 1 to 20 carbons;
R comprises one of a hydrogen, an alkyl (C1 to C20, linear or branched primary, secondary or tertiary), a cyclic alkyl, a hydroxyalkyl, a chloroalkyl, a phenyl, or a substituted phenyl; and
Z comprises a counterion.

8. The ink receiving substrate of claim 6, wherein said counterion comprises one of a halogen (F, Cl, Br, I), a hydroxyl, a methylsulfate, a tosylate, an acetate, an alkylcarboxylate, or a perchlorate.

9. The ink receiving substrate of claim 6, wherein said silane coupling agents comprise one of a Cl, Br, or methylsulfate salt of trimethylaminopropyltrimethoxysilane, triethylaminopropyltrimethoxysilane, tributylaminopropyltrimethoxysilane, or trihexylaminopropyltrimethoxysilane.

10. The ink receiving substrate of claim 1, wherein said monoamine silane coupling agents comprises from approximately 1 to 30% of said organic modified inorganic oxide particulates based on a weight of said inorganic particulates.

11. The ink receiving substrate of claim 1, wherein said silane coupling agents comprises from approximately 1 to 10% of said inorganic oxide particulates based on a weight of said inorganic particulates.

12. The ink receiving substrate of claim 1, wherein said organic oxides comprise a plurality of substituted or unsubstituted mono amino silane coupling agents.

13. The ink receiving substrate of claim 1, wherein said organic modified silica comprises a thickness of between approximately 20 μm to approximately 60 μm.

14. The ink receiving substrate of claim 1, wherein said silane coupling agents further comprise an active functional group.

15. The ink receiving substrate of claim 12, wherein said active functional group comprises one of an ultraviolet absorber, a metal chelator, a hindered amine light stabilizer, a reducing agent, a hydrophobic group, an ionic group, a buffering group, or a functionality for subsequent reactions.

16. The ink receiving substrate of claim 1, wherein said layer of inorganic oxide comprises one of a fumed silica or an alumina.

17. The ink receiving substrate of claim 16, wherein said fumed silica is distributed between approximately 0.01 and 0.03 grams per square meter.

18. The ink receiving substrate of claim 16, wherein an aggregate size of said fumed silica is between approximately 50 to 300 nm.

19. The ink receiving substrate of claim 16, wherein said alumina comprises pseudo-boehmite.

20. The ink receiving substrate of claim 1, wherein said inorganic oxides further comprises a salt of a polyvalent metal ion;
a weight % of said polyvalent metal ion being from 0 to 20% based on the weight of inorganic oxides.

21. The ink receiving substrate of claim 20, wherein said salt of a polyvalent metal ion comprises one of a trivalent aluminum, chromium, gallium, indium, thallium, tetravalent titanium, germanium, zirconium, tin, cerium, hafnium, or thorium.

22. The ink receiving substrate of claim 20, wherein said salt of polyvalent metal ion comprises one of aluminum chloride hydrate (ACH) or polyaluminum chloride (PAC).

23. The ink receiving substrate of claim 1, wherein said inorganic oxide further comprise a polymeric mordant;
a weight % of said polymeric mordant being from approximately 0 to 20% based on the weight of inorganic oxides.

24. The ink receiving substrate of claim 23, wherein said polymeric mordant comprises one of a cationic water soluble or water dispersible polymer containing a primary amino group, a secondary amino group, a tertiary amino group, a quaternary ammonium salt group, or a quaternary phosphonium salt group.

25. The ink receiving substrate of claim 23, wherein said polymeric mordant comprises one of a polyethyleneimine, a polyallylamine, a polyvinylamine, a dicyandiamide-polyalkylenepolyamine condensate, a polyalkylenepolyamine-dicyandiamideammonium condensate, a dicyandiamide-formalin condensate, an addition polymer of epichlorohydrin-dialkylamine, a polymer of diallyidimethylammoniumchloride (“DADMAC”), a copolymer of diallyldimethylammoniumchloride-SO₂, polyvinylimidazole, polyvinypyrrolidone, a copolymer of vinylimidazole, polyamidine, chitosan, cationized starch, polymers of vinylbenzyltrimethylqammoniumchloride, (2-methacryloyloxyethyl)trimethyl-ammoniumchloride, or a polymer of dimethylaminoethylmethacrylate.

26. The ink receiving substrate of claim 1, wherein said photobase layer comprises one of a opaque photographic, a coated paper, a cast coated paper, a clear film, a transparent film, or a plain paper.

27. The ink receiving substrate of claim 26, wherein said clear film comprises one of a cellulose ester or a polyester.

28. The ink receiving substrate of claim 26, wherein said opaque photographic material comprises one of a baryta paper, a polyethylene-coated paper, or a voided polyester.

29. A method for forming an ink receiving substrate comprising:
providing an photobase layer; and
dispensing an organic modified inorganic oxide particulates layer on at least one surface of said photobase layer;
wherein said organic modified inorganic oxide particulates includes inorganic particulates and substituted or unsubstituted mono amino silane coupling agents.

30. The method of claim 29, wherein dispensing an organic modified inorganic oxide particulates layer on at least one surface of said photobase layer comprises:
dispersing said inorganic particulates in an aqueous environment to form an aqueous dispersion;
dispersing said substituted or unsubstituted mono amino silane coupling agents in said aqueous environment; and
reacting said inorganic particulates and said substituted or unsubstituted mono amino silane coupling agents to form said organic modified inorganic oxide particulates.

31. The method of claim 30, further comprising coating said organic modified silica onto at least one surface of said photobase layer.

32. The method of claim 31, wherein said coating of said organic modified inorganic oxide particulates onto at least one surface of said photobase layer is performed by one of a blade coater, an air knife coater, a rod coater, a wire rod coater, a roll coater, a slot coater, a slide hopper coater, a gravure coater, a curtain coater, or a cascade coater.

33. The method of claim 30, further comprising dispersing one of aluminum chloride hydrate (ACH) or polyaluminum chloride (PAC) in said aqueous environment.

34. The method of claim 30, further comprising heating said aqueous environment to between approximately 50 and 80° C.

35. The method of claim 30, further comprising maintaining said aqueous solution at a pH of between approximately 3 and 7.

36. The method of claim 30, wherein said inorganic particulates and said substituted or unsubstituted mono amino silane coupling agents are simultaneously dispersed into said aqueous environment.

37. The method of claim 30, wherein dispensing an organic modified inorganic oxide particulates layer on at least one surface of said photobase layer comprises:
coating said photobase layer with inorganic particulates;
dispersing said substituted and/or unsubstituted mono aminosilane coupling agents in an aqueous environment to form a liquid coating composition; and
dispensing said liquid coating composition onto said inorganic particulate layer.

38. The method of claim 37, further comprising dispersing an additive into said liquid coating composition.

39. The method of claim 38, wherein said additive comprises one of a surfactant, a co-solvent, a buffer, a biocide, a viscosity modifier, a sequestering agent, a stabilizing agent, or water.

40. The method of claim 29, further comprising dispensing an organic modified silica layer on a plurality of surfaces of said photobase layer.

41. The method of claim 29, wherein said silane coupling agents have the general structure of: 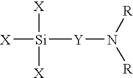
wherein:
at least one of X comprises a halogen, an alkoxy, or a hydroxyl group configured to attach to said inorganic particulates;
Y comprises a linking group containing from 1 to 20 carbons; and
R comprises one of a hydrogen, an alkyl (C1 to C20, linear or branched primary, secondary or tertiary), a cyclic alkyl, a hydroxyalkyl, a chloroalkyl, a phenyl, or a substituted phenyl.

42. The method of claim 41, wherein Y comprises one of a linear or a branched hydrocarbon, a polyethyleneoxide, a polypropylene oxide, or a polyethyleneimine.

43. The method of claim 42, wherein Y further comprises one of an alkyl, an alkylaromatic, a substituted aromatic, an ether, a urea, a urethane, an ester, a ketone, a carbonate, a sulfonate, a sulfone, or a sulfonamide.

44. The method of claim 29, wherein said silane coupling agents have the general structure of: 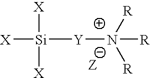
wherein:
at least one of X comprises a halogen, an alkoxy, or a hydroxyl group configured to attach to said inorganic particulates;
Y comprises a linking group containing from 1 to 20 carbons;
R comprises one of a hydrogen, an alkyl (C1 to C20, linear or branched primary, secondary or tertiary), a cyclic alkyl, a hydroxyalkyl, a chloroalkyl, a phenyl, or a substituted phenyl; and
Z comprises a counterion.

45. The method of claim 44, wherein said counterion comprises one of a halogen (F, Cl, Br, I), a hydroxyl, a methylsulfate, a tosylate, an acetate, an alkylcarboxylate, or a perchlorate.

46. The method of claim 29, wherein said inorganic particulates comprise one of a fumed silica or an alumina.

47. A system for printing inkjet images with reduced yellowing comprising:
a media sheet including a porous coating compositiori including an organic modified inorganic oxide particulates having inorganic particulates and substituted or unsubstituted mono amino silane coupling agents, and a media substrate having the porous coating composition coated thereon;
an inkjet material dispenser configured to dispense an inkjet ink onto said media sheet; and
an inkjet ink fluidly coupled to said inkjet material dispenser.

48. The system of claim 47, wherein said silane coupling agents have the general structure of: 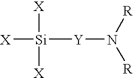
wherein:
at least one of X comprises a halogen, an alkoxy, or a hydroxyl group configured to attach to said inorganic particulates;
Y comprises a linking group containing from 1 to 20 carbons; and
R comprises one of a hydrogen, an alkyl (C1 to C20, linear or branched primary, secondary or tertiary), a cyclic alkyl, a hydroxyalkyl, a chloroalkyl, a phenyl, or a substituted phenyl.

49. The system of claim 48, wherein Y comprises one of a linear or a branched hydrocarbon, a polyethyleneoxide, a polypropylene oxide, or a polyethyleneimine.

50. The system of claim 49, wherein Y further comprises one of an alkyl, an alkylaromatic, a substituted aromatic, an ether, a urea, a urethane, an ester, a ketone, a carbonate, a sulfonate, a sulfone, or a sulfonamide.

51. The system of claim 47, wherein said silane coupling agents have the general structure of: 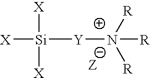
wherein:
at least one of X comprises a halogen, an alkoxy, or a hydroxyl group configured to attach to said inorganic particulates;
Y comprises a linking group containing from 1 to 20 carbons;
R comprises one of a hydrogen, an alkyl (C1 to C20, linear or branched primary, secondary or tertiary), a cyclic alkyl, a hydroxyalkyl, a chloroalkyl, a phenyl, or a substituted phenyl; and
Z comprises a counterion.

52. The system of claim 51, wherein said counterion comprises one of a halogen (F, Cl, Br, I), a hydroxyl, a methylsulfate, a tosylate, an acetate, an alkylcarboxylate, or a perchlorate.

53. The system of claim 47, wherein said inkjet ink comprises one of a pigment-based inkjet ink or a dye-based inkjet ink.

54. The system of claim 53, wherein said dye based inkjet ink comprises an anionic dye-based ink having water-soluble acid and direct dyes.

55. The system of claim 47, wherein said inkjet ink comprises an aqueous formulation.

56. The system of claim 55, wherein said inkjet ink further comprises one of a co-solvent, a surfactant, a buffering agent, a biocide, a sequestering agent, a viscosity modifier, a humectant, or a binder.

57. The system of claim 47, wherein said inkjet material dispenser comprises one of a thermally actuated inkjet dispenser, a mechanically actuated inkjet dispenser, an electrostatically actuated inkjet dispenser, a magnetically actuated dispenser, a piezoelectrically actuated dispenser, or a continuous inkjet dispenser.

58. A method for forming inkjet images resistant to yellowing comprising:
forming an ink receiving substrate; and
jetting an inkjet ink onto said ink receiving substrate;
wherein said ink receiving substrate includes a porous coating composition including an organic modified silica having inorganic particulates and substituted or unsubstituted mono amino silane coupling agents, and a media substrate having the porous coating composition coated thereon.

59. The method of claim 58, wherein said silane coupling agents have the general structure of:
X₃Si—(CH₂)n-N(R)₂
where at least one of X is a halogen, alkoxy, or hydroxyl group; and n is from 1 to 20.

60. The method of claim 59, wherein R comprises one of a hydrogen, an alkyl (C1 to C20, linear or branched, primary, secondary or tertiary), a cyclic alkyl, a hydroxyalkyl, a chloroalkyl, a phenyl, a substituted phenyl, or an alkylaromatic.
